(19) United States
(12) Patent Application Publication
(10) Pub. No.: US 2014/0178161 A1
(43) Pub. Date: Jun. 26, 2014

(54) CONVEYOR TECHNOLOGY SUPPORTED COMMISSIONING OF ARTICLES

(71) Applicant: MOSSBURGER LOGISTICS NETWORK & DEVELOPMENT KG, Graz (AT)

(72) Inventors: Michael MOOSBURGER, Fernitz (AT); Martin Gleiss, Seewalchen (AT)

(73) Assignee: Mossburger Logistics Network & Development KG, Graz (AT)

(21) Appl. No.: 13/724,901

(22) Filed: Dec. 21, 2012

(51) Int. Cl. B65G 1/137

(52) U.S. Cl. CPC B65G 1/1378
USPC 414/273; 414/267

(57) ABSTRACT

A system for commissioning articles stored on source pallets in a pallet warehouse has a supply-conveyor line for supplying source pallets from the pallet warehouse to commissioning work stations having packing stations. Customer orders are assigned to a packing station. At the packing station a customer-transporting means is provided for picking up the articles to be directly commissioned from the source pallets. An outlet conveying line removes source pallets that are no longer needed from the commissioning work station back into the pallet warehouse or to another commissioning work station. An article arrival conveying line conveys the source pallets from an article arrival to the pallet warehouse. Automated guided vehicles are provided for conveying the source pallets along the article arrival conveying line, the supply-conveyor line and/or the outlet conveying line.

### FIELD OF INVENTION

The invention relates to a system and method for the semi-automated commissioning of articles and the realization thereof by means of automated and semi-automated conveyor systems and goods-to-person work stations, comprising the supplying of source pallets via a supply-conveyor line to at least one commissioning work station having packing stations, wherein customer-transporting means are provided for picking up the articles to be commissioned, the commissioning of articles from the source pallet into the customer-transporting means by an operator at all those packing stations, which are to receive articles from the source pallet according to customer orders, the removing of the source pallet from the commissioning work station via an outlet conveying line back into the pallet ware house or to another commissioning work station.

### BACKGROUND OF THE INVENTION

The methods for the commissioning of FMCGs (fast moving consumer goods) currently employed are as follows:

a) Manual commissioning methods:

These commissioning methods have in common that a worker collects articles for customer orders by moving through the warehouse, covering longer or shorter distances. The worker is thereby supported by scanner, voice instructions, lights (pick by light) or labels and commissioning lists. The following processes are involved therein:
Classic manual commissioning: the worker drives or walks through the shelf aisles and picks up individual articles onto transporting means that are used for the delivery to the customers.
Reversed manual commissioning: if the number of the articles is smaller than the number of customers to be served, the worker will drive through a warehouse with the articles placed on an article pallet and distribute the articles onto already available costumer-transporting means.

b) Automation-supported methods of commissioning:

Herein, there is made the attempt to support or substitute, respectively, the manual work performed by the commissioner by means of machines. There is distinguished between partially automated and completely automated methods:

Partly-automated: Herein, articles that are to be distributed to customers are firstly unstacked from the original pallet into individual packages. This process may be carried out in a completely automated or a partially automated way. Thereafter, these individual packages, so-called trading units, are stored in different storing systems. A customer order is then compiled by serving these trading units individually to an automated or partially automated work station, where the customer order will be assembled by sorting the trading units into customer-transporting means.

Completely automated: Herein, the unstacking process of the trading units from the original pallet as well as the stacking process of the trading units onto the customer-transporting means are completely carried out by machines. Here the original pallet is also firstly unstacked, the individual trading units are temporarily stored in boxes, trays or channel stores and subsequently served to the commissioning station, where they are compiled to the customer-transporting means (customer pallet, rolling container, dolly, . . . ) in an automated way by robots or other technologies.

These automated methods, hence, have the following features:

Singularization of the original pallet into individual trading units

Temporary storage of the individual trading units

Compilation of the individual trading units into customer orders

With these automated methods, the following problems are encountered:

FMCGs are handled at least twice (according to the level of automation by human being or machine). In the case of a purely manual commissioning process such as described above, this happens only once. For this reason, the purely economic rentability of such systems is rather low in comparison to the manual commissioning process.

FMCGs are temporarily stored as individual trading units by means of extraordinarily expensive storage technology.

Highly complex systems: these methods are usually carried out via a manual or automated high-bay warehouse, an unstacking unit, a container warehouse for the trading units, a stapling unit and the conveyor systems arranged inbetween and software control.

Such systems are in general suitable exclusively for A-, B- or C-class items. A-class items are frequently needed articles, which are also designated as fast moving. B-class items are average frequently needed articles, which are also designated as medium moving. C-class items are seldomly needed articles, which are also designated as slow moving. For this reason, there have to be frequently combined different automated systems in order to cover the complete commissioning of an order. This results in a division of orders into different commissioning fields. The commissioned articles then have to be once again compacted upon completion in order to guarantee a full utilization and occupancy of the vehicles used for dispatch. During this compacting process, the articles will be handled for the third time.

The advantages of these automated methods and systems:
Improved ergonomics for the commissioners than in the purely manual commission process, as the work stations may be optimized for the operator; in particular, the working height may be adjusted.
In general less staff requirement, as the distances for the commissioner are omitted. This advantage, however, is counter-balanced by high expenditures in terms of skilled and trained maintenance personnel.

From the document EP 1 767 472 A1 there is known a method for commissioning articles stored on source pallets in customer-transporting means. The source pallets are supplied via conveyor belts to a commissioning work station, where an operator is already waiting. The operator picks up articles according to the order, which are then placed into already available containers. Empty pallets are subsequently transported back to a warehouse.

From the document WO 2007/124796 A1 there is further known an inverse commissioning method, wherein loading means, onto which the individual delivery orders are loaded, are provided at fixed positions. The worker moves along the commissioning aisles pulling a dolly with several source pallets that each contain one type of article and commissions, in accordance with the order, from the source pallets into the loading means that are in a fixed position.

### SUMMARY OF THE INVENTION

In view of the problems associated with the state of the art mentioned above, it is an object of the present invention to provide a system and method for the commissioning of articles, wherein the articles may be commissioned at the packing stations directly from the source pallets into a customer-transporting means.

It is another object of the invention to provide means for the efficient commissioning at the different packing stations.

A substantial aim of the present invention is also that it is to be realized by means of standard components of the conveyor technology, providing for a cheap, fast and reliable concept as well as setup of the corresponding commissioning warehouses and the operation thereof.

It is another object of the invention to provide a system for commissioning articles, which system is useful in warehouses having a plurality of storing lanes, wherein even existing warehouses can be equipped with this commissioning system according to the invention. According to this object of the invention maintenance costs and costs of investments are kept low and the system is scalable and faster than prior art systems

The present invention solves this aim by means of a commissioning system for commissioning articles stored on source pallets in a pallet warehouse according to customer orders, having a supply-conveyor line for supplying source pallets from the pallet warehouse to at least one commissioning work station having packing stations. Each customer order may be assigned to at least one of the packing stations, in which packing station a customer-transporting means may be provided for picking up the articles to be directly commissioned from the source pallets, and an outlet conveying line for removing source pallets that are not longer needed from the commissioning work station back into the pallet warehouse or to another commissioning work station.

The spirit of the invention lies in the fact that the articles on the pallets are handled only once throughout the entire course of arrival of the articles, temporary storage and commissioning process. This approach makes it possible for the articles to be moved in a single process step directly from a source pallet—this is the pallet on which the articles have been delivered to the article arrival—onto the customer-transporting means, which is delivered to the customer, without the disadvantages of long distances and lacking handling ergonomics, which are inherent to the system itself, having any influence at all. The flexibility of the stacking process, however, will be fully retained. At the same time, the invention prevents the use of complex stacking and unstacking units that are prone to defects as well as the temporary storage of individual trading units.

According to the invention, the commissioning of articles stored on source pallets in a pallet warehouse according to customer orders is carried out by supplying source pallets via a supply-conveyor line to at least one commissioning work station having packing stations, wherein customer-transporting means are provided for picking up the articles to be commissioned, by commissioning articles either manually or by robots from the source pallet into the customer-transporting means at all those packing stations, which are to receive articles from the source pallet according to customer orders, by removing the source pallet from the commissioning work station via an outlet conveying line back into the pallet warehouse or to another commissioning work station. In this regard it is essential that due to a commissioning directly from the source pallet onto the customer-transporting means there will not be accumulated any travel times for the operator or the operating robot and there will not be used a two-step-process as provided in the state of the art, wherein the articles of the source pallet are firstly singularized and only then compiled in a manual or automated way onto the target-transporting means with or without temporary storage. In order to fill up the customer-transporting means up to their maximum, there is envisaged in an embodiment of the invention to provide at each point of time only one single customer-transporting means per customer at a packing station of a work station. When this is full, the next customer-transporting means for this customer will be provided at the same or another packing station of the same or another commissioning work station.

According to the invention, the source pallets are moved at the commissioning work station on a vehicle to the packing stations, in what way the operator is released from the task of moving heavy loads. The vehicle therefore offers a work station for the operator, at which the operator may commission from the source pallet into the customer-transporting means at the individual packing station in a seated position. This provides for the advantage that the commissioner may commission especially efficiently at different packing stations into the individual customer-transporting means. This advantage is obtained by the use of the specialized vehicle at the commissioning station. Even when the operator is replaced by a robot the advantages of this embodiment remain the same.

The invention further provides for a sort buffer for source pallets, which is realized by the supply-conveyor line being configured double the length of the length a maximum number of source pallets to be removed at the same time from the pallet warehouse to the commissioning work stations would require and by the supply-conveyor line being transported on bi-directionally. In this way, it is possible to optionally supply every source pallet via the supply-conveyor line at any time to every commissioning work station.

In order to offer the operator an ergonomically optimal work station, it is further provided that the source pallets are positioned at the commissioning work station, dependent on their loading height and on the size of the operator, at a height that is ergonomic for the operator. For the same reason there is further provided that the customer-transporting means are positioned in the packing stations of the commissioning work station, dependent on their loading height and on the size of the operator, at a height that is ergonomic for the operator.

In order to prevent any erroneous commissioning processes, it is preferred that only the customer-transporting means to be commissioned is actually positioned at the working height. The probability of erroneous commissioning is further prevented by automated commissioning plausibility controls being carried out in every packing station, such as, e.g., weighing the customer-transporting means and upon detection that the determined number of articles of a source pallet has been commissioned, withdrawing the customer-transporting means from the working height.

In order to keep the configuration of the commissioning work stations and the entire system simple and to minimize the source pallet streams and, in this way, dramatically reduce the investment costs, there is further provided that slowly moving C-class items of a customer order are supplied in containers, in particular individual trading units, on trays or unpacked directly on the conveyor system to the commissioning work station and that the operator then packs the container into the customer-transporting means assigned to the customer order.

In another important aspect of the present system for commissioning articles stored on source pallets in a pallet warehouse, further comprising an article arrival conveying line provided for conveying the source pallets from an article arrival to the pallet warehouse, automated guided vehicles are provided which convey the source pallets along at least one of the article arrival conveying line, the supply-conveyor line or the outlet conveying line. This embodiment of the invention provides for low investment costs, low maintenance costs, improved operating speed, full scalability, and avoidance of single points of failure. This embodiment of the invention can easily be integrated in existing manual warehouses. The advantages of this embodiments become even more striking the more of the conveying lines are served by the automated guided vehicles. It is preferred that all conveying lines of the pallets are operated by automated guided vehicles. In this regard it is suggested to transport the customer-transporting means along a dispatch conveying line to a dispatch area by means of automated guided vehicles.

In some warehouses so called slowly moving or C-items, which are items that are less frequently commissioned than other items, are temporarily stored in pick-to-belt warehouses. In another aspect of the invention automated guided vehicles are provided which are adapted for transporting the source pallets along the article arrival conveying line to a pick-to-belt warehouse and from the pick-to-belt warehouse along another conveying line to the commissioning work stations.

It happens that customer orders reveal that a complete pallet of articles is needed to fulfill an order. Therefore, it is suggested to provide automated guided vehicles adapted for transporting source pallets along a conveying line to a complete pallet temporary storage.

Usually, each of the article arrival, the dispatch area and the commissioning area comprises a plurality of stations. Even the pallet warehouse comprises a plurality of stations (so called lanes). By means of the automated guided vehicles according to the invention it has become possible to interconnect all stations of one area with all stations of an adjacent area. This means that all areas of the commissioning system are operable in a path-optimized manner. Thereby the commissioning performance of the commissioning system is remarkably increased. Particularly, it is suggested that the article arrival comprises a plurality of arrival stations and the pallet warehouse comprises a plurality of warehouse stations, wherein all automated guided vehicles travelling between the article arrival and the pallet warehouse are adapted to approach every arrival station and every warehouse station. In another embodiment of the invention the pallet warehouse comprises a plurality of warehouse stations and a plurality of commissioning work stations are provided, wherein all automated guided vehicles travelling between the pallet warehouse and the commissioning work stations are adapted to approach every warehouse station and every commissioning work station. Further, it is suggested that a plurality of commissioning work stations are provided and that the dispatch area comprises a plurality of dispatch stations, wherein all automated guided vehicles travelling between the commissioning work stations and the dispatch area are adapted to approach every commissioning work station and every dispatch station.

When the automated guided vehicles are controlled optically, inductively, capacitively or by radio a highly reliable operation is achieved.

It should further be observed that the automated guided vehicles may either drive along optical or magnetical marks attached on the bottom, or may be guided by laser beams or cameras. Particularly, camera guided vehicles are able to define and steer a course between the source and the destination by themselves. Thereby optimal use of the available space is achievable.

In a simple embodiment of the invention the automated guided vehicles just carry out horizontal transport of the pallets. However, in a more sophisticated system the automated guided vehicles comprise lifting and lowering means for pallets transported by them, so that they are able to move the pallets vertically. With such an embodiment the advantages of the present system in regard of ergonomics and speed of the commissioning work stations can easily be implemented to existing ware houses.

In yet another aspect of the invention the commissioning work stations are equipped with robots being adapted to put articles from the source pallets into the customers transport means at those packing stations which have to receive said articles according to the customer orders. With such an embodiment most or even all of the commissioning volume can be done in an automatic manner, by replacing a human operator by said robot.

Further advantages and features of the invention become obvious upon study of the following description of exemplary embodiments in reference to the drawings.

### BRIEF DESCRIPTION OF THE DRAWINGS

FIG. 1 shows a diagram of the flow of articles from the arrival of the articles until the dispatch thereof according to the present invention.

FIG. 2 shows a schematic illustration of the logic paths of a source pallet in the source of the commissioning procedure according to the invention.

FIG. 3 shows a schematic illustration of a commissioning work station according to the invention.

FIG. 4 shows a schematic top view of a commissioning work station and substantial conveyor lines according to the invention.

FIG. 5 shows a schematic side view of the commissioning work station of FIG. 4.

FIG. 6 shows a schematic view of another embodiment of the commissioning system according to the invention, including its substantial conveyer paths.

### DESCRIPTION OF PREFERRED EMBODIMENTS

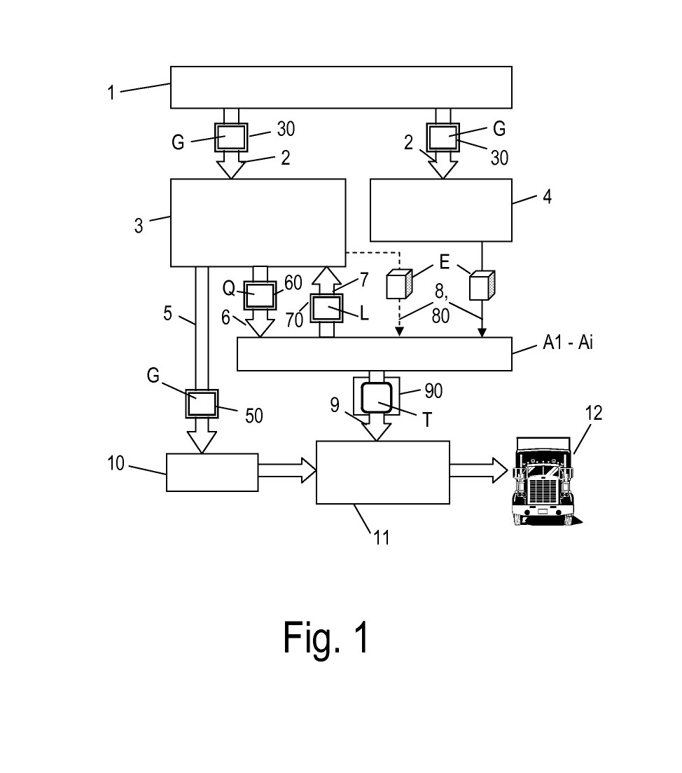

Firstly, there is described by way of FIG. 1 to FIG. 3 the flow of articles according to the present invention. In the course of arrival of articles at the article arrival 1, delivered pallets G are moved using automated guided vehicles 30 along an article arrival conveying line 2 directly into a pallet warehouse 3 and remain there until the point of time when the articles of a pallet G are required for compiling customer orders. The pallets G that are delivered at the arrival of articles 1 are either supplied by suppliers by means of transport vehicles or from the in-house production line. The pallet warehouse 3 is preferably a standard high-bay warehouse, which may be operated manually using lift trucks or also in an automated way.

In a first embodiment of the invention, the A- and B-class items are transported into the pallet warehouse 3, whereas pallets G with the C-class items are transported also using the automated guided vehicles 30 on the conveyor line 2 into a pallets pick-to-belt warehouse 4.

In an alternative embodiment, also the pallets G with the C-class items are transported into the pallet warehouse 3 and processed there. The advantage of this solution is a reduced complexity of hardware and software, as there is required one storage type less. On the other hand, the above first embodiment has the advantage that there may be configured a pick-to-belt warehouse especially adapted to the respective requirements of C-class items.

The processing of customer orders is carried out, controlled by a master computer, in batches, wherein preferably several customer orders are summarized for a common processing thereof. As can be seen in FIG. 3, each customer order is assigned to one of the packing stations K1-Kn; several packing stations K1-Kn are assigned to an operator B, alternatively a robot R, at a commissioning work station Ai, wherein several like commissioning work stations are provided, which may be manned or equipped with robots according to workload. The number of the operated commissioning work stations A1-Ai is determined by the number of customer orders, by the content thereof, by the processing time desired and by the performance of the operator or robot. The master computer calculates and correspondingly takes into account an even capacity utilization of the individual commissioning work stations A1-Ai. Also defined product sequences, which are to be followed in the commissioning, are taken into account.

The articles required for the processing of the customer orders are delivered on source pallets Q by the superior control system from the pallet warehouse 3 in a path-optimized sequence. According to the delivering sequence the source pallets Q are supplied to the commissioning work stations A1-Ai via a supply-conveyor line 6 by means of automated guided vehicles 60. The source pallets Q are either complete pallets G, i.e. not opened, or these are pallets that have been partially used, this is opened, in the course of the processing of preceding customer orders.

In particular reference to FIG. 3, there is now described the handling of source pallets Q for the commissioning work station A1 as an example. The served source pallet Q is conveyed onto a vehicle 13, on which the operator B is standing, or alternatively a robot R is mounted, and which moves back and forth between packing stations K1-Kn that are arranged on both sides thereof. By means of a lifting means, e.g., a lifting table, the source pallet Q is then positioned at a height that is ergonomic for the operator B or easy to reach for the robot R. At the same, there is positioned in one of the packing stations, e.g., in the packing station K1 that is assigned to a first customer, a first customer-transporting means T, such as, e.g., a trolley, a pallet, a dolly, etc., which is also positioned at a height that is ergonomic for the operator or easy-reachable for the robot. The operator B or robot R then puts the number of units of the articles present on the source pallet Q onto the customer-transporting means T of the first customer, wherein which number is determined by the customer order. The indication of the quantity is carried out for the operator B via a suitable electronic display. Optionally, the operator B is provided with lifting aids, e.g., a vacuum lifter. While the operator B or the robot R is still carrying out the commissioning for the first customer at the packing station K1, there is positioned at the other side of the source pallet Q in the packing station K2 a customer-transporting means T of a second customer at an ergonomic height. Once the operator B or robot R has completed commissioning at the first packing station K1, he/she/it will turn to the second packing station K2 at the opposite side and process the second customer order. In the meantime, already another customer-transporting means T will be positioned for a third customer at the next packing station K3. After the operator or robot has concluded the second commissioning process at the second packing station K2, the vehicle 13 will move further to the third packing station K3 and stop there so that the operator or robot is able to carry out the commissioning at the third packing station K3. This is followed, as described for the second packing station K2, by another commissioning process in the fourth packing station K4, and so on. There is made the provision that for each customer there is only processed one customer-transporting means T, and only when this is full, there will be provided for this customer, simultaneously for filling up, the next customer-transporting means T (provision may also be made in another packing station). This method guarantees an optimal volume utilization of customer-transporting means T and forwarding vehicles. The commissioning method described is repeated as many times as necessary.

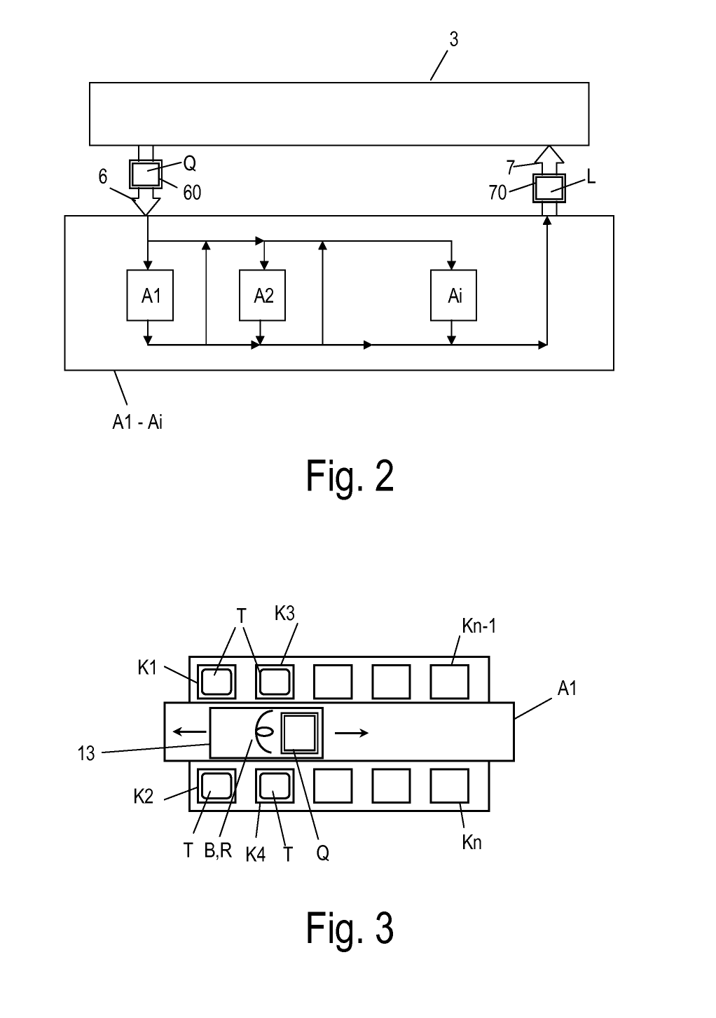

Subsequently, the then partially (“opened”) or completely empty pallet L is removed from the commissioning work station A1 and either further transported to another commissioning work station A2-Ai, or it is transported back via an outlet conveying line 7 (see FIG. 2 or FIG. 3) by means of automated guided vehicles 70 into the pallet warehouse 3 (opened pallets, which are available again as source pallets Q for further commissioning processes) or to a disposal installation for empty pallets. At the same time as removing the partially or completely emptied pallet L, there is served on the vehicle 13 of the commissioning work station Al the next source pallet Q, whereupon the vehicle starts to move into the opposite direction and the commissioning processes are repeated for the packing stations Kn-K1. In a preferred variant, the operator B or robot R is always situated on the vehicle 13 between two source pallets Q and commissions from the source pallet positioned in the direction of movement.

There is to be noted that not every customer-transporting means T has to receive articles from the “active” source pallet. Individual packing station may rather also be skipped. The configuration of the number of customers, this is the activation of the packing stations K1-Kn is arbitrary and may be determined specifically for each case. There is either attempted to provide for all customers of a batch at all commissioning work stations A1-Ai respectively one customer-transporting means T in order to minimize the number of the source pallet movements, or there is made the attempt to completely empty a source pallet at one commissioning work station with a high probability, in order to minimize the movements of source pallets between the commissioning work stations.

FIG. 2 shows the logic paths for a source pallet Q between all commissioning work stations A1-Ai and the pallet warehouse 3. There is visible that the source pallet Q may be served to any commissioning work station A1-Ai, wherein also some may be skipped and the then partially or completely emptied pallet L will be removed at the end of the path.

In FIG. 1 there is further depicted that C-class items are singularized into individual trading units E in the pallets pick-to-belt warehouse 4 in order to complete the commissions and are then served via a conveyor line 8 by means of automated guided vehicles 80 also to the commissioning work stations A1-Ai, where they are packed into the customer-transporting means T. Upon completion of a customer-transporting means T, this is transported via another conveyor line 9 by means of automated guided vehicles 90 into a dispatch area 11, where the customer-transporting means T are loaded into forwarding vehicles 12.

As it is possible that customer orders contain larger quantities of articles than stored on an entire pallet G, it is useful to transport these complete pallets G separately via a conveyor line 5 by means of automated guided vehicles 50 and optionally a complete pallet temporary storage 10 into the dispatch area 11, where these are loaded together with the customer-transporting means T of the same customer order into the forwarding vehicles 12.

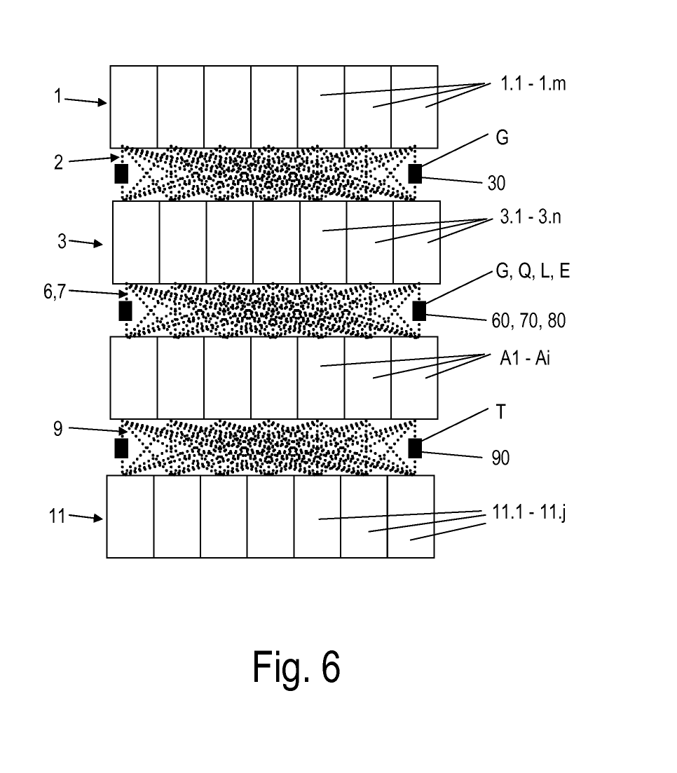

FIG. 6 shows a schematic view of the commissioning system and its essential conveying lines according to the invention. The commissioning system for commissioning articles contained on source pallets G, Q comprises an article arrival 1 consisting of a plurality of arrival stations (gates) 1.1 to 1.m. Source pallets G present in the article arrival 1 are conveyed along an article arrival conveying line 2 to the pallet warehouse 3. The pallet warehouse 3 has a plurality of warehouse stations (lanes) 3.1 to 3.n. Conveying of pallets between the article arrival 1 and the pallet warehouse 3 is accomplished by means of automated guided vehicles 30 adapted to approach every arrival station 1.1 to 1.m and every warehouse station 3.1 to 3.n. It should be emphasized that the entire space between the article arrival 1 and the pallet warehouse 3 defines the arrival conveying line 2. Alternatively, the arrival conveying line 2 may comprise pre-defined moving paths in the space between the article arrival 1 and the pallet warehouse 3.

Source pallets G and also individual trading units E are supplied from the pallet warehouse 3 to a plurality of commissioning work stations A1 to Ai by means of automated guided vehicles 60, 80. Source pallets G not longer needed are transported via an outlet conveying line 7 by means of automated guided vehicles 70 either back into the pallet warehouse 3 or to another commissioning work station A1 to Ai. Empty pallets L are also transported back into the pallet warehouse 3 via the outlet conveying line 7 by means of automated guided vehicles 70. Each automated guided vehicle 60, 70 (and optionally 80) is adapted to approach every warehouse station 3.1 to 3.n and every commissioning work station A1 to Ai. It should be emphasized that the entire space between the pallet warehouse 3 and the commissioning work stations A1 to Ai defines the supply conveying line 6 and the outlet conveying line 7. Alternatively, the supply conveying line 6 and the outlet conveying line 7 may comprise pre-defined moving paths in the space between the pallet warehouse 3 and the commissioning work stations A1 to Ai.

Customer-transporting means T which have been filled at the commissioning work stations A1 to Ai are transported to a dispatch area 11 along a dispatch conveying line 9 by means of automated guided vehicles 90. The dispatch area 11 comprises a plurality of dispatch stations (gates) 11.1 to 11.j. Each automated guided vehicle 90 is adapted to approach every commissioning work station A1 to Ai and every dispatch station 11.1 to 11.j. It should be emphasized that the entire space between the commissioning work stations A1 to Ai and the dispatch area 11 defines the dispatch conveying line 9. Alternatively, the dispatch conveying line 9 may comprise pre-defined moving paths in the space between the commissioning work stations A1 to Ai and the dispatch area 11.

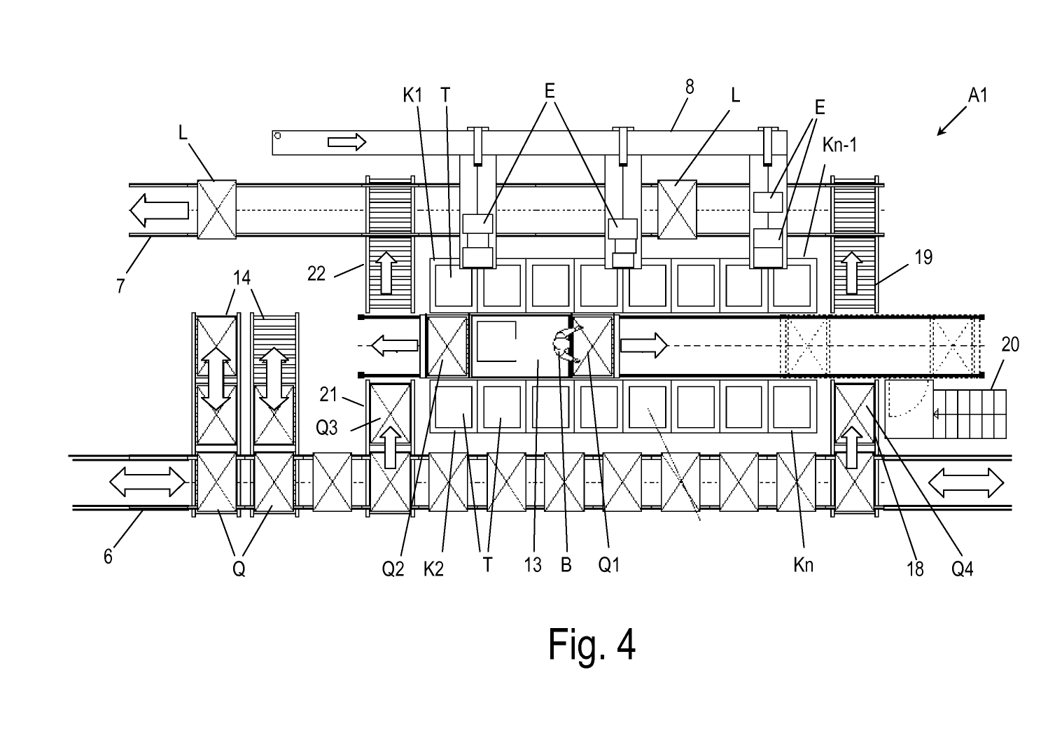

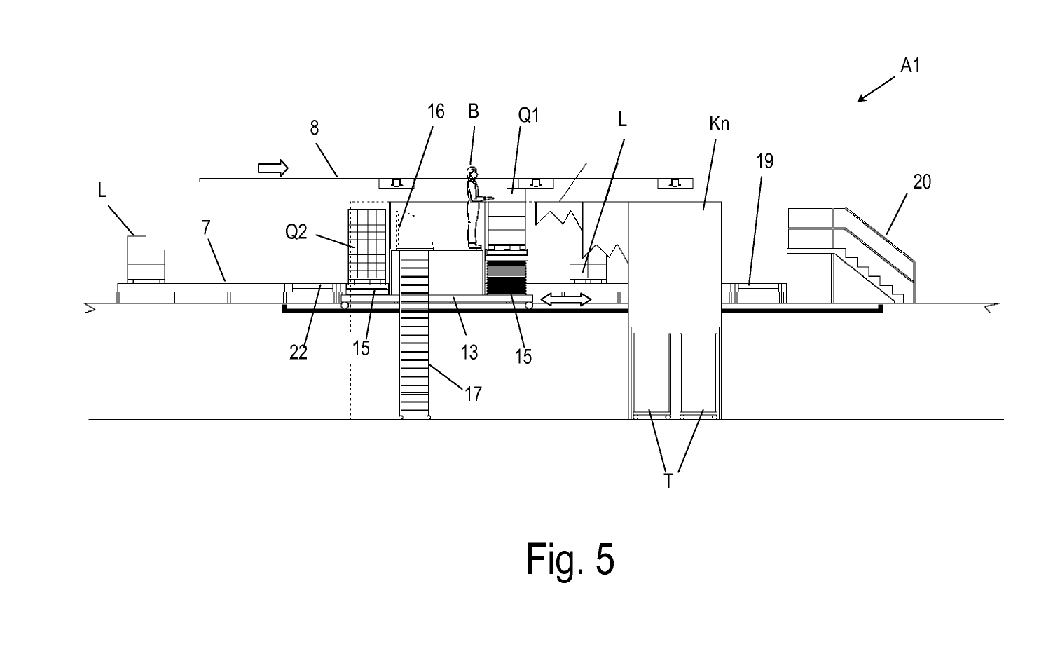

By way of the illustrations of FIG. 4 and FIG. 5, there is now given a detailed description of a commissioning work station A1 according to the invention and a substantial conveyor line to and from the commissioning work station A1.

Via the supply-conveyor line 6 that is realized by way of standard conveyor systems, the source pallets Q, controlled by a superior master computer, are served from the pallet warehouse to the commissioning work station A1. The supply-conveyor line 6 is configured as a bi-directional conveyor line, the length of which is double the length a maximum number of source pallets (Q) to be removed at the same time would require and, hence, serves as a sort buffer. In addition, or in order to shorten the length of the supply-conveyor line 6, it comprises intermediate buffers 14 for subsequent pallets. The operator of the commissioning work station A1 stands on the vehicle 13 moving in the viewing direction of the operator B. To the left and right of the vehicle 13, there are situated the packing stations K1-Kn. In front of the operator B, there is arranged a source pallet Q1, from which the operator is currently commissioning articles into customer-transporting means T of the packing stations K1-Kn according to the customer order. There is to be noted that the operator B has positioned behind his back a second source pallet Q2, from which the operator will commission on the vehicle's 13 way back. There is further to be noted that both source pallets Q1, Q2 stand on lifting tables 15 on the vehicle 13, by means of which they are lifted up to a height that is ergonomic for the operator. From the drawing it becomes obvious that the partially emptied source pallet Q1 is already substantially higher than the full source pallet Q2. The adjusted height of the lifting tables 15 is permanently adjusted, either in an automated way or controlled by the operator.

But not only the source pallets Q1, Q2 on the vehicle 13 may be adjusted in height, but rather also the customer-transporting means T in the packing stations K1-Kn, which are configured as shafts, into which in the floor area the customer-transporting means T may be introduced and removed and which are lifted during commissioning by means of lifting means, which are not displayed, up to a height that is ergonomic for the operator. Therewith, there is provided in order to prevent an erroneous commissioning that there is positioned only the customer-transporting means T to be commissioned at the working height, whereas the remaining customer-transporting means T are positioned at a height that may not be reached by the operator. By only one source pallet Q1, Q2 and one customer-transporting means T being simultaneously “active”, this is, accessible for the operator B, there is achieved a system-dependent error rate of zero.

Furthermore, there may be carried out automated commissioning plausibility controls in the packing stations K1-Kn, e.g., by continuously weighing the customer-transporting means T. In this way it is possible to guarantee that the correct amount of articles will be picked from the source pallet Q1, Q2. If weighing has determined that the predetermined number of articles has been commissioned from the source pallet Q1, Q2, the customer-transporting means T will be withdrawn from the working height and, hence, will not be accessible for the operator B anymore.

In order to enable the operator B to quickly leave the vehicle in the case of an emergency, there is provided an emergency ladder 17, accessible via a valve 16. The vehicle 13 then moves forth, until even the last packing station Kn has been commissioned and then moves further on until the source pallet Q1 is in a position between an inlet station 18 and an outlet station 19. In this position the source pallet Q1 is then moved out of the vehicle 13 onto the outlet conveyor line 7 and, simultaneously, the next source pallet Q4 that is already available on the inlet station 18 is loaded onto the vehicle 13. The operator B then turns around, the vehicle moves backwards, and the operator B commissions from the source pallet Q2 until the vehicle 13 reaches a position between an inlet station 21 with already available next source pallet Q3 and an outlet station 22. In this position the source pallet Q2 is then moved out of the vehicle 13 onto the outlet conveyor line 7 and, simultaneously, the source pallet Q3 is loaded onto the vehicle 13. The partially or completely emptied pallets L that are removed onto the outlet conveyor line 7 are either returned to the pallet warehouse 3 or via a—not depicted—conveyor loop transported back onto the supply-conveyor line 6 in order to serve other work stations (of course, only the partially emptied pallets and not the empty ones).

By means of the inlet stations 18, 21 and the supply-conveyor line 6 that may be transported on bi-directionally, any source pallet Q that is situated on the supply-conveyor line 6 (or in the intermediate buffers 14, respectively) may be supplied to the commissioning work station A1, in this way providing for a reliable and cheap sort buffer. There is to be noted that, when the vehicle 13 in the drawing furthest to the right is situated in an end position, the operator B may enter and leave the vehicle 13 via an entry 20.

The commissioning of articles from the source pallets Q is configured for fast and medium moving articles, this is A- and B-class items. Slowly moving C-class items are served in individual trading units via the conveyor line 8 by means of conveyor systems to the commissioning work station A1 and packed by the operator B into the customer-transporting means T at the determined packing stations K1-Kn. Due to this integration of slowly moving articles at the same commission work station, there is omitted for customer orders containing A, B and C-class items to provide for a second customer-transporting means T. Singularizing of the C-class items into individual trading units E has already been carried out in the pallets pick-to-belt warehouse 4, where the individual trading units E are manually placed onto the conveyor line 8; this may alternatively, however, also be carried out in the pallet warehouse 3, as described above. The conveyor line 8 comprises sorters that are usual in this line of business for the placed individual trading units, so that these may be served in the proper sequence and directly to the commissioning work stations.

1. A system for commissioning articles stored on source pallets in a pallet warehouse according to customer orders, having a supply-conveyor line for supplying source pallets from the pallet warehouse to at least one commissioning work station having packing stations, wherein each customer order may be assigned to at least one of the packing stations, in which packing station a customer-transporting means may be provided for picking up the articles to be directly commissioned from the source pallets, and an outlet conveying line for removing source pallets that are no longer needed from the commissioning work station back into the pallet warehouse or to another commissioning work station.

2. A system according to claim 1, wherein the supply-conveyor line is configured double the length of the length a maximum number of source pallets to be removed at the same time from the pallet warehouse to the commissioning work stations would require and that the supply-conveyor line operates bi-directionally, by means of which it serves as a sort buffer for the source pallets.

3. A system according to claim 1, wherein the commissioning work station has a vehicle for transporting source pallets along the packing stations, wherein the vehicle has a work station for an operator.

4. A system according to claim 3, wherein the vehicle has a lifting means, in particular a lifting table, onto which the source pallets may be positioned and adjusted in height.

5. A system according to claim 1, wherein the packing stations have lifting means, by means of which the customer-transporting means may be positioned and adjusted in height.

6. A system according to claim 5, wherein only the customer-transporting means to be commissioned is positioned at a working height for an operator by means of the lifting means of the respective packing station.

7. A system according to claim 5, wherein there are provided in each packing station automated commissioning plausibility check means, in particular scales for weighing the customer-transporting means, wherein the commissioning plausibility check means, upon detection that a determined number of articles of a source pallet has been commissioned, will control the lifting means of this packing station so that the customer-transporting means withdraws from the working height.

8. A system according to claim 1, wherein there is provided a conveyor line for slow C-class items to the commissioning work stations.

9. A system according to claim 1, wherein the supply-conveyor line has intermediate buffers for subsequent source pallets.

10. A system according to claim 1, wherein each commissioning work station has at least one inlet station, which takes over the source pallets from the supply-conveyor line, temporarily stores and conveys these to the vehicle.

11. A system according to claim 1, wherein each commissioning work station has at least one outlet station, which takes over the source pallets from the vehicle and conveys these to the outlet conveying line.

12. A system for commissioning articles stored on source pallets in a pallet warehouse according to claim 1, further comprising an article arrival conveying line for conveying the source pallets from an article arrival to the pallet warehouse, wherein automated guided vehicles are provided which convey the source pallets along at least one of the article arrival conveying line, the supply-conveyor line or the outlet conveying line.

13. A system according to claim 12, wherein automated guided vehicles are provided for transporting the customer-transporting means along a dispatch conveying line to a dispatch area.

14. A system according to claim 12, comprising automated guided vehicles adapted for transporting the source pallets along the article arrival conveying line to a pick-to-belt warehouse and from the pick-to-belt warehouse along another conveying line to the commissioning work stations.

15. A system according to claim 12, comprising automated guided vehicles adapted for transporting source pallets along a conveying line to a complete pallet temporary storage.

16. A system according to claim 12, wherein the article arrival comprises a plurality of arrival stations and the pallet warehouse comprises a plurality of warehouse stations, wherein all automated guided vehicles travelling between the article arrival and the pallet warehouse are adapted to approach every arrival station and every warehouse station.

17. A system according to claim 12, wherein the pallet warehouse comprises a plurality of warehouse stations and a plurality of commissioning work stations are provided, wherein all automated guided vehicles travelling between the pallet warehouse and the commissioning work stations are adapted to approach every warehouse station and every commissioning work station.

18. A system according to claim 13, wherein a plurality of commissioning work stations are provided and wherein the dispatch area comprises a plurality of dispatch stations, wherein all automated guided vehicles travelling between the commissioning work stations and the dispatch area are adapted to approach every commissioning work station and every dispatch station.

19. A system according to claim 12, wherein the automated guided vehicles are controlled optically, inductively, capacitively or by radio.

20. A system according to claim 12, wherein the automated guided vehicles comprise lifting and lowering means for pallets transported by them.

21. A system according to claim 1 or claim 12, wherein the commissioning work stations are equipped with robots being adapted to put articles from the source pallets into the customers transport means at those packing stations which have to receive said articles according to the customer orders.
